(19) United States
(12) Patent Application Publication
(10) Pub. No.: US 2004/0137897 A1
(43) Pub. Date: Jul. 15, 2004

(54) Flow-through using an automated main distribution frame

(76) Inventor: Joe Teixeira, Mount Royal (CA)

Correspondence Address: SWIDLER BERLIN SHEREFF FRIEDMAN, LLP, 3000 K STREET, NW, BOX IP, WASHINGTON, DC, 20007, US

(21) Appl. No.: 10/429,861

(22) Filed: May 6, 2003

(51) Int. Cl. H04Q 7/20; H04H 1/00; H04M 1/00

(52) U.S. Cl. 455/423; 455/425; 379/441

(57) ABSTRACT

An AMDF supporting Flow-Through management, allows a telecommunications provider OSS to maximize the automation of provisioning subscribers to services. Accordingly once a subscriber order is entered into the OSS, the remainder of the provisioning process may be automated, where-by the OSS communicates the connect and/or disconnect order to the AMDF EMS, which in turn communications with the AMDF controller and finally the AMDF performs the required cross connect. Upon completion of the cross-connect the AMDF would report the completion to the OSS, in order for the OSS to update its provisioning database. With Flow-Through automation, errors typically introduced due to human error are drastically reduced or may even be eliminated altogether.

The overall time, cost and associated errors to provision a subscriber using an AMDF supporting Flow-Through as compared to today's fully manual method will be significantly lower, leading to a significant increase in subscriber satisfaction. ILECs will also be in a much better position to honor their responsibilities toward the CLECs with respect to providing service in a timely and cost effective manner.

### FIELD OF THE INVENTION

The present invention relates generally to systems and methods for delivering telecommunications services to subscribers and, more particularly, to automating the process of service provisioning at manned and unmanned central offices, remote terminals, the equipment and services available in multi-tenant buildings.

### BACKGROUND OF THE INVENTION

There is an ever increasing demand placed on ILECs, CLECs and ISPs (referred to here-in also as telecom providers) to provide voice and data services to subscribers in a short period of time and at a lower price. These services include but are not limited to POTS, T1/E1, xDSL and ISDN. The growth of the internet as a communications tool has caused a proliferation in the number of telephone and data line connections and disconnections that are made between manned/unmanned central office and outside plant facilities. Outside plant facilities may include remote terminals, the equipment and services available in multi-tenant buildings and subscriber homes and businesses.

Delivering telecommunications services has conventionally been most expensive for the telecommunications connection between the manned/unmanned central office and the outside plant facility. For example, every time that a new residential or business subscriber is added to the telephone and/or data network, the telecom operator taking the new subscriber order must begin a lengthy process that starts by entering the new subscriber's order details into the telecom provider's computerized Operation Support System (OSS). Once the new subscriber details are entered, the OSS searches its database to locate which manned/unmanned central office or outside plant facility located in the area of the new subscriber is available to service the new subscriber. It then determines which wire pairs from the facilities need to be connected to the subscriber and notifies the OSS provisioning module of the work required to provide one or more services to the new subscriber.

The work required is in essence a work order. The work order may be a printed report of new connections to be made, given to the technician at the beginning of each day. Alternatively, the information in a work order may be transmitted electronically to a device that the technician is carrying or from which the technician may himself print work orders for a given day.

With work orders in hand, the technician is dispatched in a truck to the manned/unmanned central office or outside plant facility containing the manual copper Main Distribution Frame (MDF) to service the new subscriber location. The technician opens the MDF, locates the wires identified in the work order that extend to the subscriber and connects the line from the subscriber's house or business to the line going to the manned/unmanned central office or outside plant equipment providing the requested service. The connections are made manually using patch cords. The technician completes the process by closing the MDF, returning to his office and logging on to an internal provisioning system to close the work order, which generally updates a database to reflect the changes. Technicians are also similarly dispatched to disconnect service and in some instances to change service as needed.

Presently, as outlined above, technicians must be dispatched to initiate service, discontinue service and make service changes for land line telephone and data subscribers. This is because the typical MDF, located in a manned/unmanned central office, remote terminal or multi-tenant building, that connects telecom services to subscribers, is not automated. It is expensive to employ a fleet of trucks and service technicians to connect and disconnect telecommunications services and to make service changes. In all cases the work orders are generated by the provisioning module of the telecom OSS. In addition, due to the human element and because multiple people and independent steps are involved, mistakes can be made at several points throughout the process, which further adds to the cost and time required to provide or remove a given service.

Accordingly, there is a need for a new system and method for initiating, discontinuing and changing land line telecommunications services for subscribers, while maintaining the MDF concept of offering a plurality of subscribers access to a plurality of telecommunication services. There is a further need for provisioning systems that do not require dispatching a technician to the manned/unmanned central office or outside plant. There is a further need for a provisioning system and method that is does not require issuing work orders to technicians or dispatching technicians to perform manual service changes such as initiating new service, changing or upgrading an existing service or terminating service at equipment installed within a service area.

### SUMMARY OF THE INVENTION

According to the present invention, the conventional manual patch panel within a central office or outside plant facility is either entirely or partially substituted by an automated main distribution frame (AMDF), that is managed remotely to perform the function of connecting and disconnecting subscriber homes and businesses to and from telecommunications manned/unmanned central office and/or outside plant equipment and services. The AMDF control is provided by a remote management server.

According to one embodiment of the invention, the remote management may be provided by a process referred to as flow-through by direct machine to machine communications between the telecom computerized provisioning system & database, traditionally referred to as an OSS and software for managing the AMDF. As an alternative to flow-through provisioning, a technician or operator at a terminal connected via the Internet or other network to the remote management server may perform remote service provisioning.

Accordingly AMDF deployment in central offices, remote terminals and multi-tenant buildings supports flow-through provisioning within a telephone network and allows for direct communications with the ILEC, CLEC and/or ISP OSS so that service orders entered into the OSS are communicated directly and automatically implemented at the remote AMDF. In the event that flow-through of a particular connect or disconnect order is not possible for any given reason, a centrally located technician or operator is alerted by an alarm condition and may then access the AMDF remotely from a terminal connected to the management server to diagnose a potential problem and correct the problem without having to go directly on site. In the event that flow-through did not take place because it is an order of a particular type requiring human intervention due a specific condition which must be met prior to performing the operation or requiring additional human input, then an operator can remotely perform the connect, change or disconnect function once the specific condition is met.

According to one embodiment of the invention, an automated facility for making telecommunications connections based on remote management includes an automated main distribution frame (AMDF) and a controller. The AMDF is operative to create interconnections, in accordance with connection signals, between a plurality of subscriber lines and a plurality of exchange lines extending to a central office. The controller is operative to receive control signals from a remote management facility and to issue connection signals to the automated main distribution frame to change the interconnections.

According to another embodiment of the present invention, a method of automating telecommunications customer service changes includes receiving a work order from a telecommunications service provider that identifies an AMDF facility and a subscriber line for a change. The method further includes issuing a command to the AMDF for changing the subscriber line connection. The method may further include making the connection in the AMDF and sending a message to the telecommunications service provider indicating that the connection within the AMDF has been made.

An AMDF may comprises many cross-points arranged in a matrix configuration. Several matrix arrangements may be used such as single tier (cross-bar), three tier and banyan to name a few. Cross-points which provide the actual contact may be implemented using solid-state switches, relays, micro-relays, or stepper motors which push and pull conductive pins in the hole of a peg-board type multi-layer Printed Circuit Board (PCB. In the case of optical connections, optical switches perform the cross-point function. In addition to the cross-connect portion of the AMDF, a controller is required which provides outward connectivity to a Local area Network (LAN), Wide Area Network (WAN) or dial-up network, supporting industry standard or proprietary protocols, allowing the telecom OSS or AMDF EMS to remotely manage the AMDF system and providing inward connectivity to the cross-connect portion of the AMDF. The AMDF controller may be a separate unit connected locally to the cross-connect portion of the AMDF or it may be located within the AMDF.

### BRIEF DESCRIPTION OF THE FIGURES

The above described features and advantages of the present invention will be more fully appreciated with reference to the following detailed description and appended figures in which:

FIG. 1 depicts the conventional deployment of connection infrastructure between central offices and subscribers according to the prior art.

FIG. 2A depicts deployment of automated connection infrastructure according to an embodiment of the present invention.

FIG. 2B depicts an internal view of facility that an AMDF incorporating voltage surge protection on outdoor lines.

FIG. 3 depicts an internal block diagram of a remote terminal according to an embodiment of the present invention.

FIG. 4 depicts an internal block diagram of a central office according to an embodiment of the present invention.

FIG. 5 depicts an internal block diagram of a multi-tenant building according to an embodiment of the present invention.

FIG. 6 depicts a block diagram of a network operating center according to an embodiment of the present invention.

FIG. 7 depicts a flow diagram of an OSS work order process according to an embodiment of the present invention.

FIG. 8 depicts a flow diagram of a remote management process for supporting flow through according to an embodiment of the present invention.

FIG. 9 is an exemplary block diagram of a management server according to an embodiment of the present invention.

### DETAILED DESCRIPTION

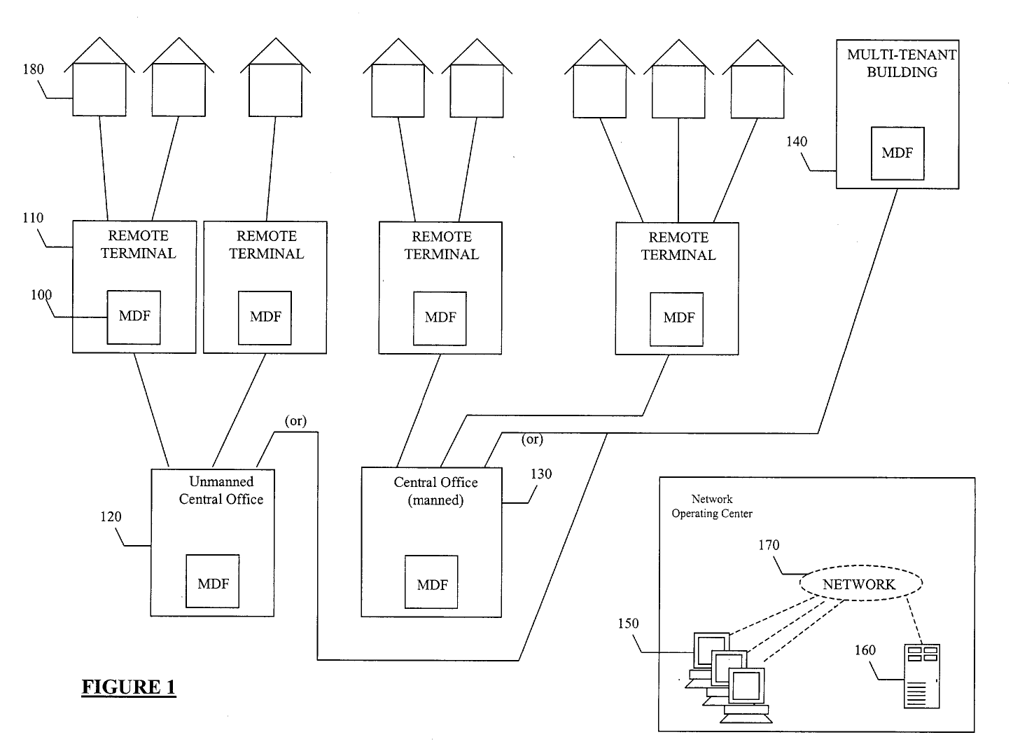

FIG. 1 depicts the conventional deployment of connection infrastructure between central offices and subscribers according to the prior art. Referring to FIG. 1, central offices 120 and 130, which may be unmanned or manned, are connected to subscriber locations 180 and a multi-tenant building 140 via intermediate remote terminals 110. Each unmanned or manned central office facility 120 and 130, remote terminal facility 110 and multi-tenant building facility 140 contains a main distribution frame (MDF) 100 that creates connections between lines extending toward the subscriber and lines extending toward the central office or to internal equipment within the facility.

Each MDF 100 includes at least one passive panel that has receptacles to receive subscriber lines and to receive other lines for connecting to those subscriber lines. In order to change a connection on MDF, a technician must be dispatched to drive to the site to manually change the connection.

In order to maintain the connection infrastructure between central offices and subscribers according to FIG. 1, telephone service providers have network operating centers (NOCs) that implement operations support systems (OSS) that support the daily operation of the telecommunications infrastructure. For example, the OSS server 160 is generally connected to one or more work order terminals 150 via a local or wide area network 170.

These work order terminals 150 are used by technicians for data entry and for retrieving work orders. For example, technicians may interact with subscribers who request a new telephone service or a cancellation of a telephone service. The service may be basic telephone service or a service upgrade such as digital subscriber line (DSL) service or other value added service. The technicians may enter the service change into the terminals 150 for processing by the OSS server 160.

The OSS server 160 generates work orders for technicians based on the service changes requested in order to have the changes implemented. The work orders identify the central office or outside plant facility where each change needs to be made and the connections within that facility that need to be changed.

The work orders are printed at the terminals 150 by technicians who will actually physically visit each central office or outside plant where connections need to be changed and make the changes identified in the work order. The technicians also use the terminals 150 to report completion of the work orders to the OSS server 160. The purpose of reporting completion is to maintain a database on the OSS server 160 that attempts to reflect the actual connection state of the manual connection infrastructure in the field. However due to human error, the database and actual cross connect state do not always entirely match. This may happen when a technician incorrectly reads a work order or incorrectly connects/disconnects a wire pair in a manned/unmanned central office or outside plant facility.

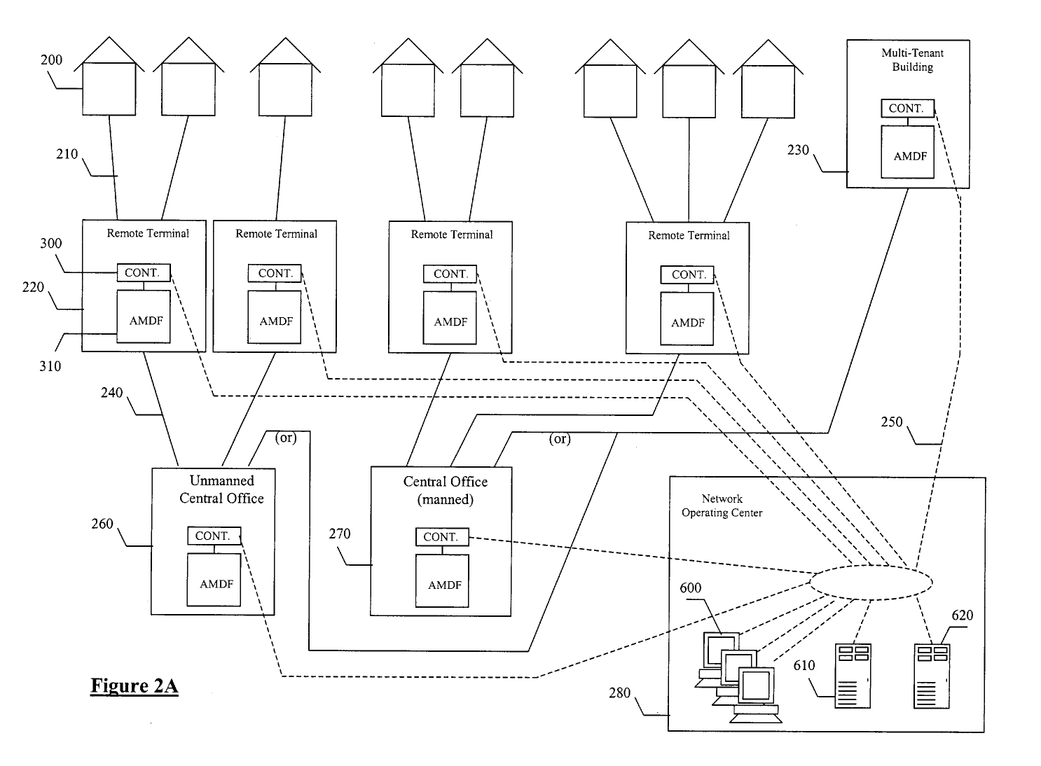

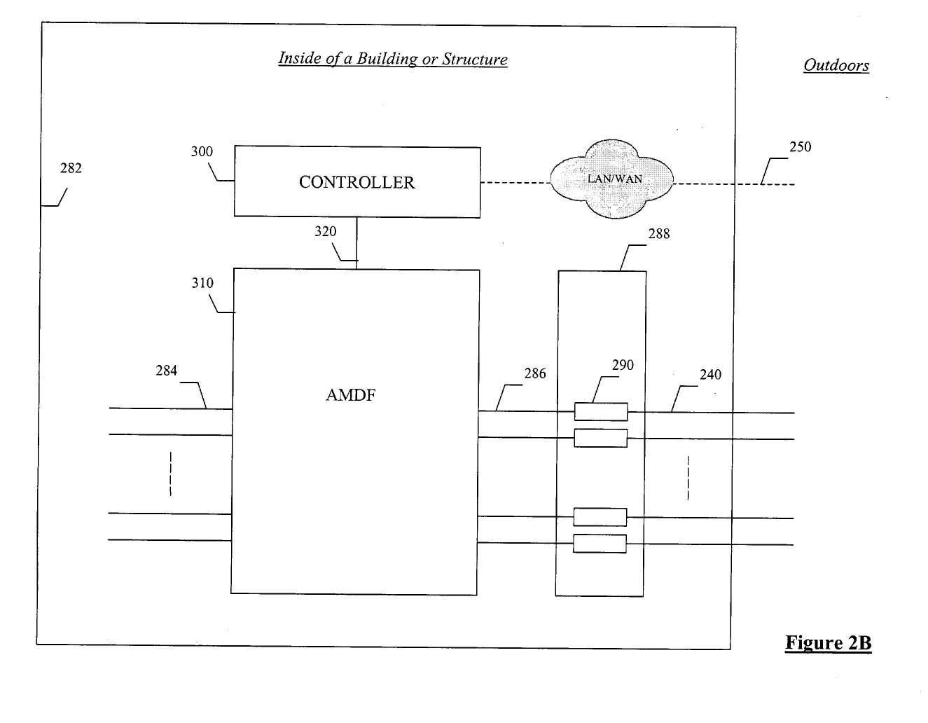

FIG. 2A depicts a deployment of automated connection infrastructure within a telephone network according to an embodiment of the present invention. This infrastructure includes automated main distribution frames (AMDFs) as part of the central offices and outside plants within the telephone network and allows flow through provisioning of service, as explained in more detail below. Referring to FIG. 2, homes and businesses 200 are physically coupled over wires or lines 210 to remote terminals 220. The remote terminals 220 are then physically coupled over wires or lines 240 to unmanned central offices 260 and manned central offices 270. Multi-tenant buildings 230 also may be physically wired to manned central offices 270 or unmanned central offices 260, directly or indirectly, via a remote terminal 220. Within each remote terminal 220, multi-tenant office building 230 and the central offices there may be at least one AMDF 310. The AMDF includes ports that are physically connected to lines that extend to (i) the subscriber equipment, (ii) lines that extend to central offices or (iii) local equipment within the central office, remote terminal or multi-tenant building facility. The AMDF includes an internal switching matrix that allows it to internally connect each port to one or more other ports. The AMDF generally includes a command interface through which the AMDF accepts remotely generated commands to change the port interconnections automatically. The controller 300, shown in FIG. 2, may provide commands to the AMDF. Alternatively, the AMDF may incorporate an internal controller and the commands may come directly from the network operations center, depending on the implementation.

Referring to FIG. 2A, the AMDF may comprise an automated cross-connect switch, such as the CONTROLPOINT™ switch available from NHC and described in U.S. Pat. No. 6,470,074. The term AMDF is intended to mean any switch capable of reliably interconnecting telecommunications signals, including voice and data signals, from inputs to outputs under the influence of internal or external control signals. The switching fabric of the AMDF may include many cross-points arranged in a matrix configuration. Several matrix arrangements may be used such as single tier (cross-bar), three tier and banyan to name a few. Cross-points which provide the actual contact may be implemented using solid-state switches, relays, micro-relays, or stepper motors which push and pull conductive pins in the hole of a peg-board type multi-layer Printed Circuit Board (PCB). In the case of optical connections, optical switches perform the cross-point function.

In addition to the cross-connect portion of the AMDF, a controller is required which provides outward connectivity to a Local area Network (LAN), Wide Area Network (WAN) or dial-up network, supporting industry standard or proprietary protocols, allowing the telecom OSS or a management server to remotely manage the AMDF system and providing inward connectivity to the cross-connect portion of the AMDF. The AMDF controller may be a separate unit connected locally to the cross-connect portion of the AMDF or it may be located within the AMDF. For convenience, the figures of the instant application illustratively depict the controller as being a separate entity.

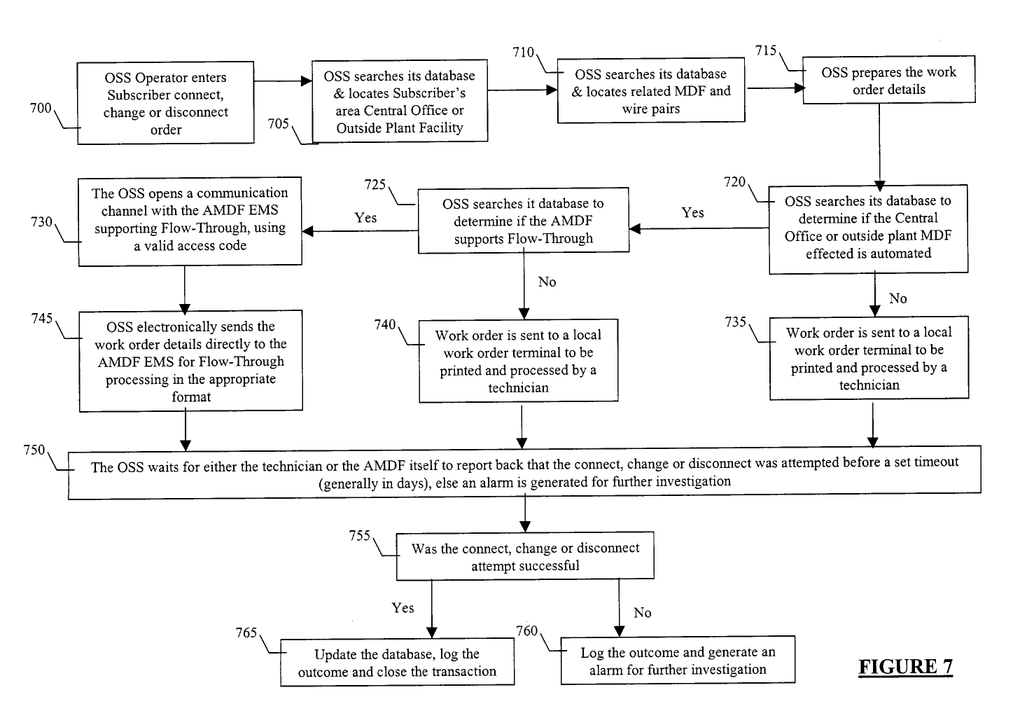

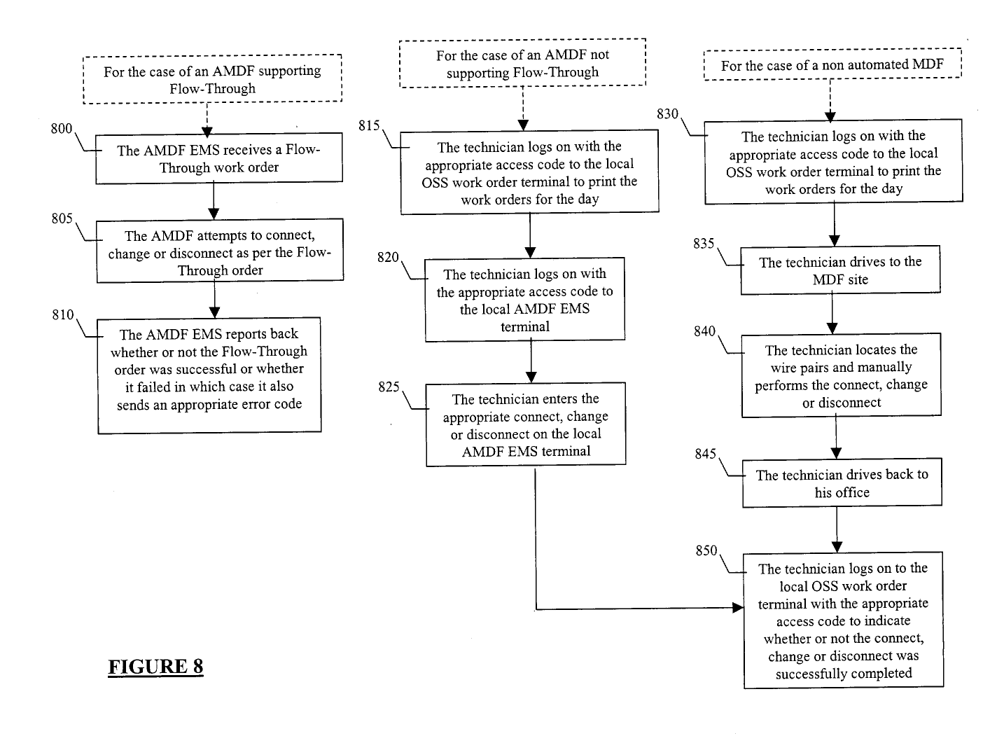

The automated connection infrastructure is controlled from a network operations center (NOC) 280. The NOC includes a remote management server 620, an OSS server 610 and terminals 600 that are coupled together via a network 250. The server 620 is coupled to the AMDFs 310 either directly or via a controller 300. The server 620 is operative to issue commands to the AMDF to create new connections, to break old connections or both. In this manner, connections between subscribers and equipment within the central office may be changed at each remote terminal or central office under remote control, without dispatching a technician to each site. As explained with reference to FIGS. 7 and 8, the terminals 600 may be used by technicians to change connections within the remote terminal electronically, monitor connections within the telephone network and monitor work orders generated by the OSS.

In addition, the terminals 600 may be used by technicians to create service changes for subscribers. The service change requests may be transmitted to the OSS server 610, which may use the change requests to generate work orders from. The work orders identify the AMDF equipment changes that need to be made in order to change the office equipment to which a particular piece of subscriber equipment is connected. The work orders from the OSS server 610 may be communicated to the management server 620 via the network. The management server 620 receives the work order and uses the information in the work order to generate commands that are transmitted over the network to cause connections within the AMDF to implement the service change.

FIG. 2B depicts a manner of protecting indoor equipment and the AMDF from outdoor wires exposed to possible high voltage or lighting surges. This structure 282, which may represent a manned central office 270, unmanned central office 260, remote terminal 220 or multi tenant building 230 (as shown on FIG. 2), houses an AMDF Controller 300 connected to a AMDF 310. The AMDF 310 is in turn connected via lines 286 to a Voltage Arrester/Lighting Arrester panel 288. The Voltage Arrester/Lighting Arrester panel 288 is in turn connected to the outdoor wires 240 and protects the AMDF 310 from outdoor originating high voltage and lighting surges which may be carried by the outdoor wires 240. The Voltage Arrester/Lighting Arrester panel 288 provides such protection to outdoor wires prior to them being physically wired 286 to ports of the AMDF 310. There may be additional Voltage Arrester/Lighting Arrester panels 288 (not shown) that are connected to additional outdoor wires that are destined for connection to ports of the AMDF 310. Arrester panels are well known.

In this manner, outdoor wires may be cross-connected through the AMDF 310 and physically wired to indoor equipment (not shown) or to another Voltage Arrester/Lighting Arrester panel 288 (not shown) if such lines are destined for the outdoors as well. The Voltage Arrester/Lighting Arrester panel 288 houses a plurality of individual Voltage Arresters/Lighting Arresters 290, at least one per wire pair intended for the outdoors 240.

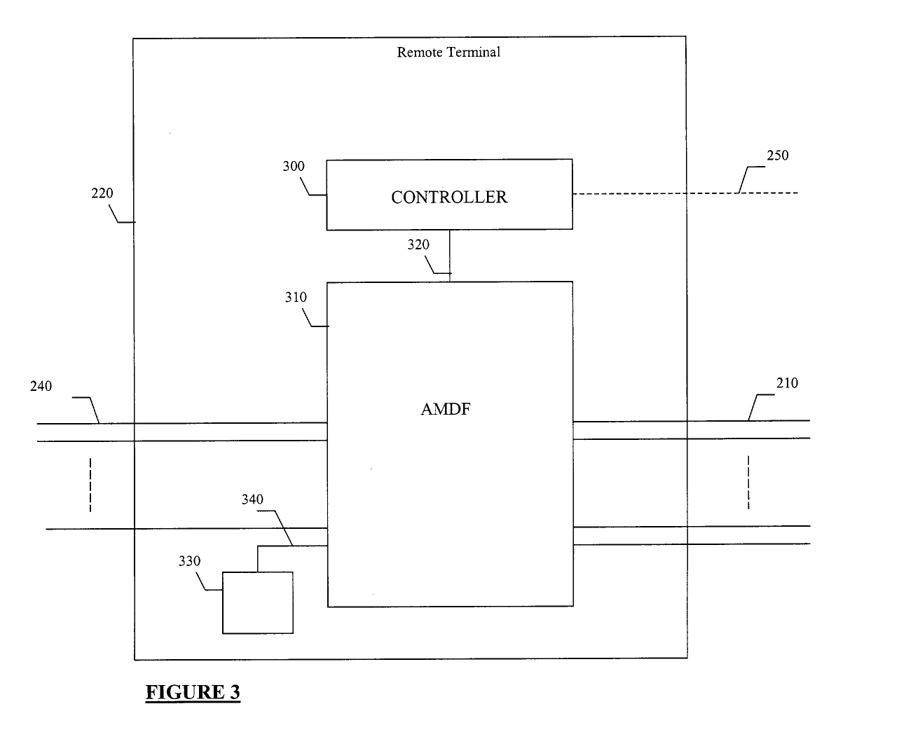

FIG. 3 depicts an internal block diagram of a remote terminal 220 according to an embodiment of the present invention. The remote terminal 220 is used to connect subscriber lines to office equipment within the central office and in some instances within the remote terminal itself. Referring to FIG. 3, the remote terminal 220 includes an AMDF 310, a controller 300 and optional local equipment 330. The AMDF 310 includes a plurality of ports that are connected to (i) subscriber wires or lines 210 extending to subscriber premises, (ii) central office lines 240 extending to the central office and equipment within the central office, and (iii) local equipment. The local equipment may be a telecommunications switch, such as a class 5 switch, a DSLAM or any other type of equipment for providing service to a subscriber.

The AMDF 310 is connected to the controller 300 via a line 320. The line 320 may be any convenient kind of connection including a wireless, optical or electrical connection. In the case of a physical connection, it may include an RS-232 connection or any other convenient connection. The controller 300 is coupled to the management server 620 within the network operation center via a network connection 250, which may be a wireless, optical or electrically wired connection. The server 620 issues control signals to the controller 300 which cause the controller 300 to issue commands to the AMDF to change the connections among its ports in a desired way. The controller may perform a protocol translation between the server 620 and the AMDF. The controller may also transmit a signal over the network line 250 back to the management server to indicate that the connection change has been made. The AMDF 310 automatically performs the actual physical cross connects.

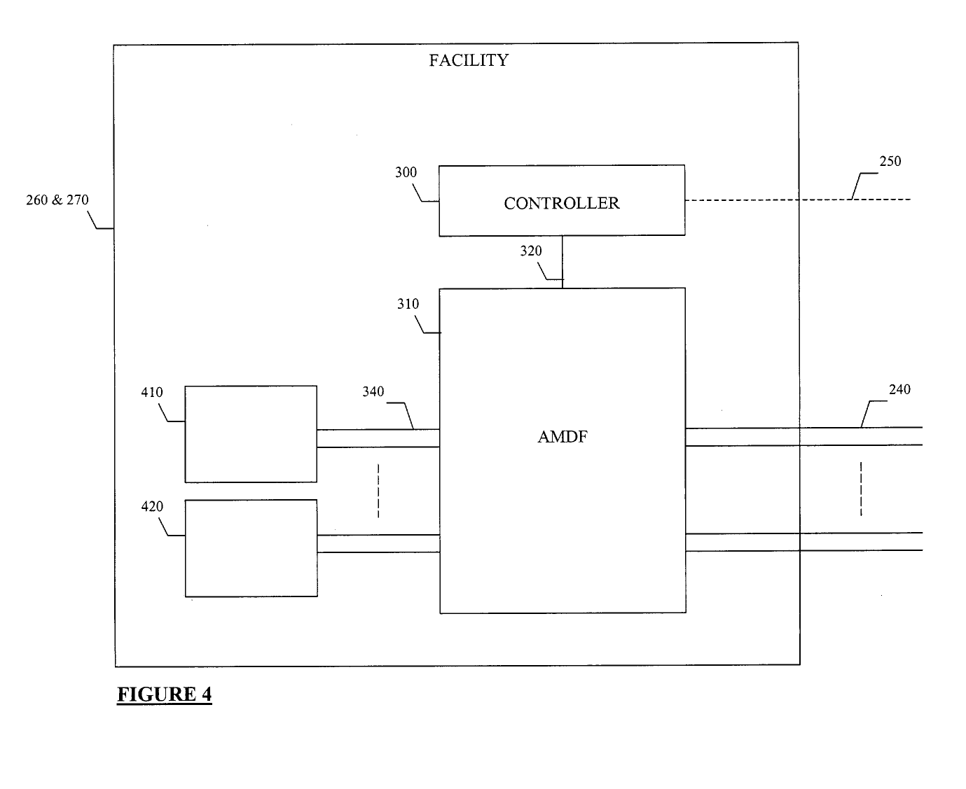

FIG. 4 depicts an internal block diagram of a central office 260 or 270 according to an embodiment of the present invention. The central office includes an AMDF which includes ports to which to connect wires, such as tip and ring pairs, for automated cross connection according to an embodiment of the present invention. The AMDF includes ports that are connected to (i) local POTS equipment 410 via local equipment lines 340 (ii) local data equipment 420 via local equipment lines 340 and (iii) lines 240 going to remote terminals 220 and multi-tenant buildings 230 which eventually terminate at subscriber equipment.

The ports of the AMDF are interconnected under the remote management of the AMDF 310 via a network connection 250 to the network operations center. According to one embodiment, the network connection line 250 connects directly to the controller 300, which in turn connects locally 320 to the AMDF 310. The management server 620 issues commands to the controller 300 requesting the AMDF to change interconnections between its ports in a desired way to cause a change of service. The controller issues a connection command to the AMDF based on the commands received from the management server 620. The controller 300 may perform a protocol translation between the management server 620 and the AMDF 310. The AMDF 310 performs the actual physical cross connects in response to connection commands received from the controller 300 or the server 620.

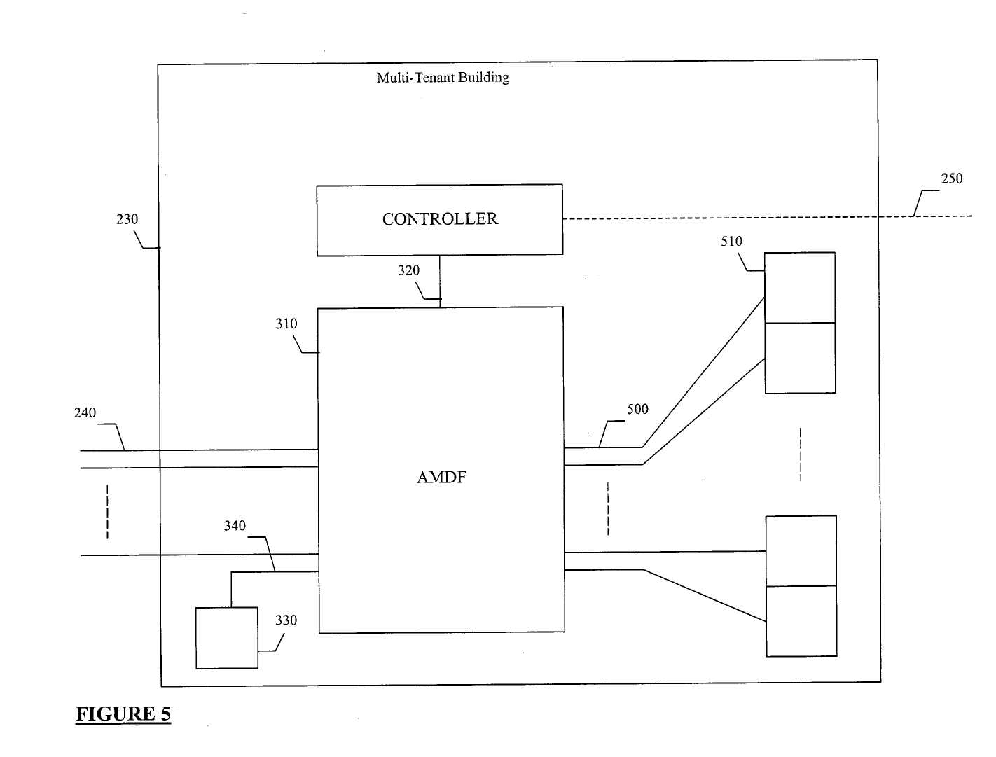

FIG. 5 depicts an internal block diagram of a multi-tenant building 230 according to an embodiment of the present invention. The building 230 may include an AMDF 310 and its corresponding controller 300, local equipment 330 and building subscriber equipment 510. The ports of the AMDF 310 are connected to the local equipment 330 via the lines 340, to the central office (or a remote terminal) via lines 240 and to building subscriber equipment 510 by lines 500. The interconnections between the ports of the AMDF are made under the remote management of the AMDF 310 via a network connection 250 between the server 620 and the controller 300. The AMDF 310 performs the actual physical cross connects.

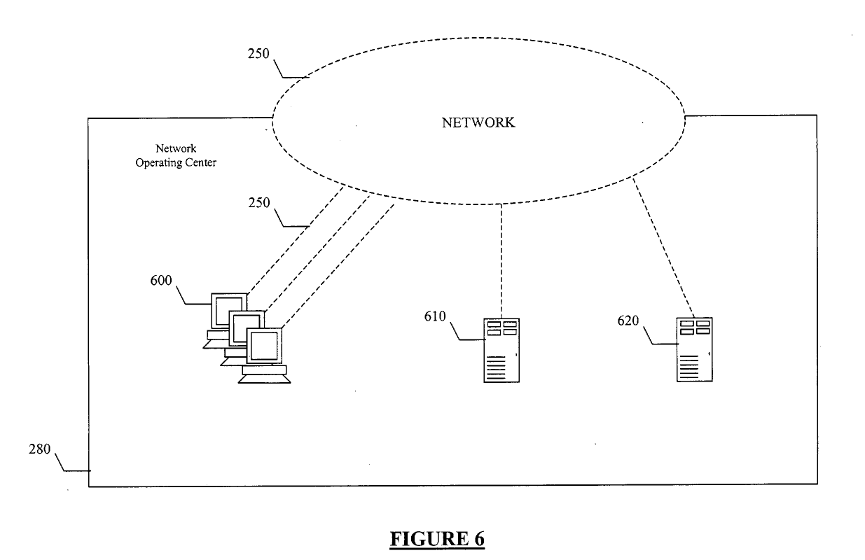

FIG. 6 depicts a block diagram of a network operating center (NOC) 280 according to an embodiment of the present invention. The NOC 280 includes a network 250 that couples an OSS server 610, a connection management server 620 and terminals 600. The connection management server 620 remotely manages each AMDF in the telephone network via LAN/WAN links 250 to the controller associated with each AMDF or group of AMDFs.

The terminals 600 may run a client application or browser and communicate with a server 620. Technicians at the terminals may communicate with the management server 620 to monitor the AMDF connections in the field and instruct the management server to make changes to the connections in the field. In addition, the OSS software running on the telecommunications OSS Server 610 may automatically and directly communicate connect and/or disconnect work orders to the remote management server 620, across the LAN/WAN 250. The remote management server 620 then relays the connect and/or disconnect orders to the controller 300 of the affected site, via the LAN/WAN 250. The controller in turn issues a command to the AMDF 310, via a local connection 320, to actually perform the requested connect and/or disconnect function. The controller returns via the LAN/WAN a confirmation message to the remote management server 620 indicating that the connection was made and the remote management server 620 communicates this to the OSS's 610. In turn, the OSS server 610 updates its internal database of connections to reflect the change.

FIG. 7 depicts a flow diagram of an OSS work order process according to an embodiment of the present invention. Referring to FIG. 7, in step 700, an OSS operator enters subscriber connect, change or disconnect order into a terminal. In step 705, the OSS server 610 receives the order and searches its database to locate the subscriber's central office or outside plant facility. In step 710, the OSS server 610 searches its database to identify the related MDF and wire pairs associated with the subscriber that need to be changed. There may be more than one wire pair that is affected by the change order. In addition, each wire pair generally has an action associated with it, such as a disconnect action or a connect action. In step 715, the OSS server generates a work order that includes the identity of the subscriber's central office or outside plant facility, the identity of the related MDF and wire pairs that are affected by the change order and the action to be taken with respect to each related wire pair. In step 720, the OSS server queries its database to determine if the MDF in the outside plant facility identified in the work order is automated and supports flow through order processing.

If the MDF identified in the work order is not automated, then step 735 begins. In step 735, the OSS server sends the work order to a work order terminal via the network to be manually retrieved and processed by a technician. The technician retrieves the work order and physically visits the outside plant identified in the work order and manually performs the actions identified in the work order. After step 735, step 750 begins.

In step 725 the OSS searches its database to determine if the AMDF of the outside plant identified in the work order supports flow through processing. If not, then step 740 begins. In step 740, the work order is sent to a work order terminal coupled to the OSS server 610 for processing by a technician. The OSS maintains a queue of outstanding work orders that need processing by a technician. The technician then log onto the terminal and, one by one, operates the remote management server 620 via the terminal to issue commands to the AMDFs identified in the work orders. By issuing commands, the technician remotely commands an AMDF to change its internal port interconnections in order to make the service changes identified in each work order. The technician in this manner makes infrastructure changes to the telecommunications network remotely using the terminal, without having to physically visit each central office or outside plant to make the changes manually. After step 740, step 750 begins.

In step 730, the OSS server determines, based on steps 720 and 725 that the AMDF identified in the work order does support flow through processing. The OSS server 610 therefore opens a communication channel with the management server 620. The communications channel may be any convenient communications channel, including a point to point telephone connection, a packet switched local or wide area network connection or any other convenient connection. The connection may include some security requiring the OSS server to provide an access code in order to establish the communications channel.

In step 745, the OSS server sends the work order directly to the remote management server for flow through processing. The OSS server may forward the work order electronically as a message to the management server 620. Alternatively, the OSS server may first format the information in the work order to a predetermined format expected by the management server 620 prior to sending the work order electronically. For example, the OSS may send the work order information as an electronic message, an electronic mail document, a wireless SMS message, a XML or other hypertext document or any other convenient document or electronic format. Upon receipt of the work order message, the remote management server queues the work orders for processing.

For each work order, the management server dispatches commands via the network 250 to the controller associated with each affected AMDF in the field to carry out the changes in connections. The controller then commands the affected AMDF to change its internal port interconnections and sends a message back to the management server 620 indicating if the connection change was successful or if the connection change was not successful. After step 745 completes, then step 750 begins.

The flow-through work orders may be of varying types. For example, they may be: immediate orders such as connect, or disconnect orders; related order such as change orders which may involve one or more disconnects and connects with interdependencies; orders involving miscellaneous equipment such as splitters in the case of ADSL which may require a number of connects and possibly some disconnects; or orders with set due dates which can not be performed prior or which must be performed before hand, depending on the type; or orders requiring human intervention or authorization before they can be completed.

In step 750, after dispatching a work order, the OSS waits for a response from either the technician or the remote management server 620, depending on whether or not the order is of the Flow-Through type, before a set timeout occurs. The timeout may send an alarm indicating that the work order has been left outstanding, typically for more than a predetermined number of days.

In step 755, after the predetermined time limit for processing the work order, the OSS server determines if the work order was successfully processed. This determination is made based on whether the OSS server received confirmation from a technician or the management server 620 that the work order was processed successfully. If the work order was processed successfully, then in step 765, the OSS server updates its database to log the outcome and close the transaction. If the work order was not processed successfully, then in step 760, the OSS server logs the outcome, includes any error codes reported, and generates an alarm for further processing and investigation by a technician. Alternatively, in the non-successful case, the technician may attempt to resolve the problem on his own, and then report a successful response to the OSS work order terminal once the problem has been resolved.

FIG. 8 depicts a flow diagram of a remote management process for supporting flow through according to an embodiment of the present invention. The flow diagram of FIG. 8 depicts OSS software processes that are run on or interact with the OSS server 610. The terms OSS software and OSS server are used interchangeably. Referring to FIG. 8, when the work order is a flow-through work order, then step 800 begins. In step 800, the management server receives a flow-through order reflecting a change in the deployment of connection infrastructure within the telephone network.

In step 805, the management server processes the information in the work order including the identity of the AMDF affected by the change order, the identity of the wire pairs affected by the change order and the actions required for each wire pair for the work order. Based on this information in the work order, the management server issues a command to the controller 300 associated with the AMDF 310 affected by the work order, over the network 250. The controller 300 receives the command and causes the AMDF 310 to make the connection changes required by the command. The controller reports back success or failure to the management server 620.

In step 810, the management server 620 receives a message from the controller as to whether or not the work order was successfully processed and communicates that information in the form of a message back to the OSS server 610. If not successful, the management server 620 may send a message that includes one or more error codes indicating the nature of the failure.

If the work order is destined for an AMDF but is not a flow-through order, then in step 815 a technician logs onto a terminal with an appropriate access code. The technician is then able to print non-flow through work orders that have been queued for execution by that technician or that technician's department for the day. In step 820, the technician logs on to his local management server terminal with a valid access code. In step 825, the technician issues commands to the AMDF's identified in each work order to fulfill the AMDF changes identified in each work order 825 that the technician is processing. Upon completion of one or more of the work orders, in step 850, the technician then logs on to the local OSS work order terminal with the appropriate access code to indicate whether or not the connect, change or disconnect was successfully completed. If a work order requires a technician to visit outdoor plants to make connection changes within the telephone network manually, then step 830 begins. In step 830, a technician logs on to the local OSS work order terminal using a valid access code. He is then presented with the work orders for the day which he prints for reference. In step 835, the technician then drives to each manned/unmanned central office or outside plant facility identified in a work order. In step 840, the technician then accesses the subscriber wire pairs that are identified in the work order as requiring changes and makes the connect, change or disconnect as per the work order 840. The technician then returns to his office in step 845. In step 850, the technician logs on to the local OSS work order terminal with the appropriate access code to indicate whether or not the connect, change or disconnect was successfully completed.

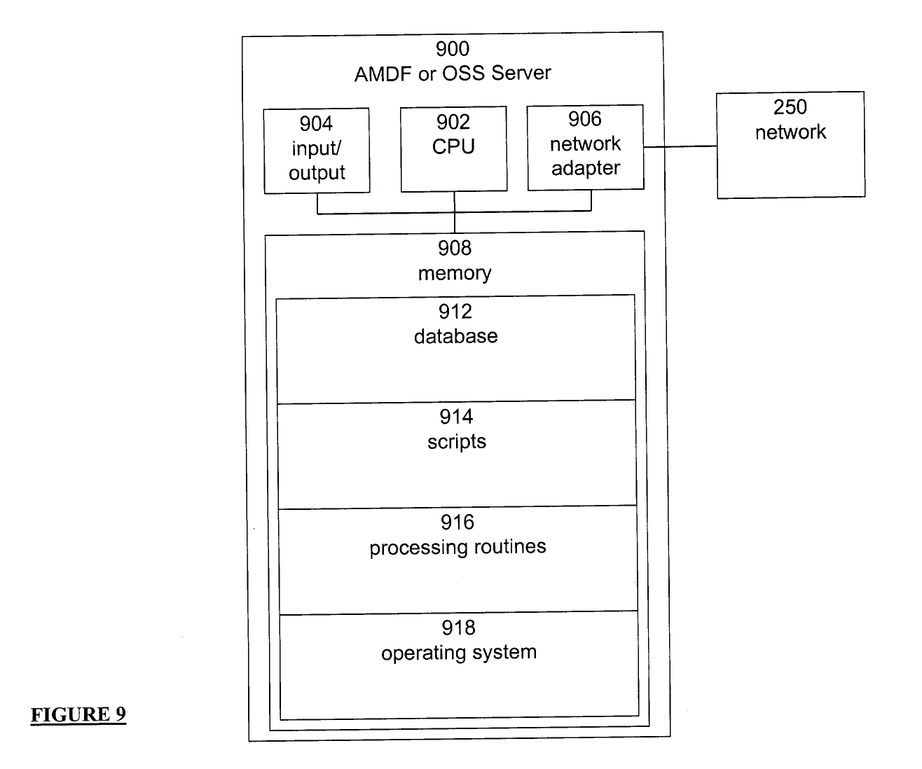

FIG. 9 depicts an exemplary block diagram of a typical computer server which may represent the management server 620 and/or the OSS server 610, according to an embodiment of the present invention. The processes of FIG. 9 may be embodied in OSS software, an OSS server, management software or a management server that directs the processes. The terms management software and server are used interchangeably.

Referring to FIG. 9, the server computer 900 may be a programmed general purpose computer system, such as a personal computer, workstation, server system, minicomputer or mainframe computer, but in this type of application will typically be a server. The server 900 includes processor (CPU) 902, input/output circuitry 904, network adapter 906, and memory 908. CPU 902 executes program instructions in order to carry out the functions of the present invention. CPU 902 may be a microprocessor, a workstation processor, a server processor (typical case in this situation), a minicomputer or mainframe computer processor. Input/output circuitry 904 provides the capability to input data to, or output data from, server system 900. For example, input/output circuitry may include input devices, such as keyboards, mice, touchpads, trackballs, scanners, etc., output devices, such as video adapters, monitors, printers, etc., and input/output devices, such as, modems, etc. The network adapter 906 interfaces the network operations center 280 with a network 250. The network 250 may be any local area network (LAN) or wide area network (WAN), such as Ethernet, Token Ring, the Internet, or a private or proprietary LAN/WAN. Typically, however, the network is an IP network such as the Internet. Note that a serial dial-up network may also be used instead of an IP based LAN/WAN.

Memory 908 stores program instructions that are executed by, and data that are used and processed by, CPU 902 to perform the functions of the present invention. Memory 908 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

Memory 908 includes a plurality of blocks of data, such as database 912 and scripts block 914, and a plurality of blocks of program instructions, such as processing routines 916 and operating system 918. Database 912 stores information relating to configuration and cross-connects maintained on the AMDF for the management server or AMDF EMS server case and configuration, mapping, cross connect, equipment and subscriber billing information for the OSS server case. The database 912 may be separate for the servers 610 and 620 or may be integrated and shared in whole or in part by the servers 610 and 620. When the servers 610 and 620 are implemented as a single server, the database similarly may comprise a single database or may be separate databases for the management software and the OSS software. Scripts block 914 includes scripts that are transmitted by the OSS server 610 to the AMDF EMS or management server 620 to cross-connect subscriber lines to service equipment lines. Processing routines 916 are software routines that implement the processing performed by the present invention, such as sending and receiving cross-connect messages, accessing the associated database 912, transmitting scripts from script block 914, etc. Operating system 918 provides overall system functionality.

The methods shown and described relative to FIGS. 7 and 8 may be embodied in software program instructions that are stored within the memory 908 and executed by the CPU 902 of the computer 900 to cause the computer 900 to perform the steps indicated. The software program instructions may be embodied on a CD ROM or other storage media and loaded into the memory in any convenient manner.

Although specific embodiments of the present invention have been described and in some cases not fully described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. An automated facility for making telecommunications connections based on remote management, comprising:
an automated main distribution frame operative to create interconnections, in accordance with connection signals, between a plurality of subscriber lines and a plurality of exchange lines extending to a central office; and
a controller operative to receive control signals from a remote management facility and to issue connection signals to the automated main distribution frame to change the interconnections.

2. The automated facility according to claim 1, further comprising:
local equipment having ports connected to the automated main distribution frame;
wherein the automated main distribution frame selectively connects subscriber lines to the local equipment ports based on the connection signals.

3. The automated facility according to claim 1, wherein connection signals are operative to change the interconnections by making at least one connection.

4. The automated facility according to claim 1, wherein connection signals are operative to change the interconnections by breaking at least one connection.

5. The automated facility according to claim 1, wherein the controller is coupled to the remote management facility via a network link.

6. The automated facility according to claim 5, wherein the network link is physically implemented as a telecommunications line.

7. The automated facility according to claim 5, wherein the network link is physically implemented as an optical link.

8. The automated facility according to claim 5, wherein the network link is physically implemented as a wireless link.

9. The automated facility according to claim 1, wherein the remote management facility includes a server having management software that initiates changes of connections within the automated main distribution frame.

10. The automated facility according to claim 9, further comprising:
a central office OSS that communicates work order information to the management software to initiate a change of connections within the automated main distribution frame.

11. The automated facility according to claim 9, wherein the OSS is part of the management software.

12. The automated facility according to claim 9, wherein the OSS is not part of the management software.

13. The automated facility according to claim 1, wherein the controller performs a protocol translation between the remote management system and the automated main distribution frame.

14. The automated facility according to claim 9, wherein the controller may be controlled over the network by another computer.

15. The automated facility according to claim 1, wherein the controller includes a craft port allowing it to be locally controlled by a technician.

16. The automated facility according to claim 1, wherein the facility is located in a manned central office.

17. The automated facility according to claim 1, wherein the facility is located in an unmanned central office.

18. The automated facility according to claim 1, wherein the facility is located in a remote terminal.

19. The automated facility according to claim 1, wherein the facility is located in a multi-tenant building.

20. The automated facility according to claim 1, wherein the AMDF comprises a matrix of cross-points used to establish the physical connections.

21. The automated facility according to claim 20, wherein one of relays, micro-relays, stepper motors which insert and remove conductive pins in a hole, solid state switches, and optical switches are used as the basic AMDF cross-point component arranged in a matrix.

22. The automated facility according to claim 20, wherein the cross-points are arranged in a single tier (or cross-bar) matrix architecture.

23. The automated facility according to claim 20, wherein the cross-points are arranged in a three tier matrix architecture.

24. The automated facility according to claim 20, wherein the cross-points are arranged in a banyan tier matrix architecture.

25. A method of automating telecommunications customer service changes, comprising:
receiving an electronic work order from an OSS that identifies an automated main distribution frame facility and a subscriber line for a change; and
issuing a command to the automated main distribution frame for remotely changing the subscriber line connection according to the work order.

26. The method according to claim 25, wherein the work order further specifies an office equipment line for connecting to the subscriber line through the automated main distribution frame.

27. The method according to claim 25, wherein the work order further specifies a port of office equipment for connecting to the subscriber line through the automated main distribution frame.

28. The method according to claim 25, further comprising:
making the connection change within the automated main distribution frame based on the command.

29. The method according to claim 28, further comprising:
sending a message to the telecommunications service provider indicating that the connection within the automated main distribution frame has been made.

30. The method according to claim 25, wherein the command is automatically issued based on the work order.

31. The method according to claim 25, wherein the command is issued based, on the work order, by a technician processing work orders from a terminal.

32. A method of automating telecommunications customer service changes, comprising:
generating a work order that identifies a facility and a subscriber line for a change;
determining whether the facility is equipped to support flow through processing; and
issuing electronically the work order to a management system to automatically make the change when the facility is determined to support flow through processing.

33. The method according to claim 32, further comprising:
issuing electronically the work order to a management system for queuing and terminal processing when the facility is determined to be automated but to not support flow through processing.

34. The method according to claim 32, further comprising:
issuing electronically the work order to a management system for queuing and printing by a service technician when the facility is determined not to be automated.

35. The method according to claim 32, further comprising:
receiving an indication from the management system that the change has been made successfully.

36. The method according to claim 35, further comprising:
updating a database to reflect the changed connections within the facility based on the indication.

37. The method according to claim 32, further comprising:
receiving an indication from the management system that the change has not been made successfully.

38. The method according to claim 37, further comprising:
generating an alarm based on the indication from the management system that the change has not been made successfully.

39. The method according to claim 32, further comprising:
entering into a terminal subscriber information upon which to based a change in subscriber connections; and
generating the work order based on the subscriber information.

40. The method according to claim 39, further comprising:
identifying connections and the facility that houses the connections for changes based on the subscriber information; and
adding the facility and connections to the work order in the generating step.

41. The method according to claim 40, further comprising:
determining whether the facility identified includes an automated main distribution frame for handling the connections; and
adding an indication that the facility is automated to the work order in the generating step when the facility is determined to include an automated main distribution frame for handling the connections.
